(19) United States
(12) Patent Application Publication
(10) Pub. No.: US 2005/0135792 A1
(43) Pub. Date: Jun. 23, 2005

(54) Compact multimedia player

(75) Inventor: Loi Han, Alhambra, CA (US)

Correspondence Address: COUDERT BROTHERS LLP, 333 SOUTH HOPE STREET, 23RD FLOOR, LOS ANGELES, CA, 90071, US

(73) Assignee: Microtek International, Inc.

(21) Appl. No.: 11/016,284

(22) Filed: Dec. 17, 2004

Related U.S. Application Data
(60) Provisional application No. 60/531,437, filed on Dec. 19, 2003.

(51) Int. Cl. H04N 5/781

(52) U.S. Cl. 386/125; 386/126

(57) ABSTRACT

The present invention provides for a compact media player capable of playing a variety of audio and visual data embedded in a variety of media data formats, including but not limited to CD, CD-R, CD-RW, VCD, DVD, DVD-R, DVD-RW, DVD+R, DVD+RW, and SD memory card. The player can also be used to receive TV broadcast signals and AM, FM and/or XM radio broadcast signals. In one embodiment, the compact media player can also perform computing functions. Also, the player of the present invention can be used as a means to transmit and receive media data to other media devices through A/V, USB and/or wireless interfaces. The player can also record incoming media data sources through those interfaces.

### CROSS-REFERENCE TO RELATED APPLICATION(S)

The present application claims the benefit of priority from pending U.S. Provisional Patent Application No. 60/531,437, entitled “Compact Multimedia Player,” filed on Dec. 19, 2003, which is herein incorporated by reference in its entirety.

### BACKGROUND OF THE INVENTION

1. Field of the Invention

The present invention relates to a compact multimedia player.

2. Description of the Prior Art

Portable electronic media players, such as portable versions of CD players, DVD players, TVs, and radios are well known. However, no known device provides the capability to play back multiple media formats and provide broadcast-receiving, computing, or recording functionalities.

### OBJECTS AND SUMMARY OF THE INVENTION

It is an object of the present invention to provide a compact multimedia player capable of playing a variety of audio and visual data embedded in a variety of media data formats, including but not limited to CD, CD-R, CD-RW, VCD, DVD, DVD-R, DVD+R, DVD-RW, DVD+RW and SD memory card formats.

It is an object of the present invention to provide a compact multimedia player capable of recording media data to a variety of optical disc data formats including but not limited to CD-R, CD-RW, DVD-R, DVD+R, DVD-RW, DVD+RW and SD memory card formats.

It is an object of the present invention to provide a compact multimedia player capable of performing computing functions and receiving TV broadcast signals and radio broadcast signals in AM, FM and XM formats.

It is an object of the present invention to provide a compact multimedia player capable of interfacing with a wide variety of other media devices through A/V (Audio/Visual), USB (Universal Serial Bus) and wireless interfaces and recording incoming media data from those devices through those interfaces.

### BRIEF DESCRIPTION OF THE DRAWINGS

These and other features, aspects and advantages of the present invention will become better understood with regard to the following description, appended claims and accompanying drawings where:

FIG. 1A is a perspective view of a first preferred embodiment of the present invention;

FIG. 1B is a perspective view of a second preferred embodiment of the present invention;

FIG. 2A is a perspective view of the first preferred embodiment of the present invention with the antennas extended;

FIG. 2B is a close-up view of the first preferred embodiment of the present invention;

FIG. 2C is a perspective view of the first preferred embodiment of the present invention in the open position;

FIG. 3A is a perspective view of the second preferred embodiment of the present invention with the antennas extended;

FIG. 3B is a perspective view of the second preferred embodiment of the present invention with the antennas retracted;

FIG. 3C is a perspective view of the second preferred embodiment of the present invention in the open position;

FIG. 4A is a cut-away view showing the A/V connector interface and volume control on one side of the player;

FIG. 4B is another cut-away view showing the connector interfaces on the other side of the player;

FIG. 4C is a view showing the battery compartment on the back side of the player;

FIG. 5 is a schematic diagram of internal components of an embodiment of the present invention; and

FIG. 6 is a flow chart diagram outlining the software control functions of an embodiment of the present invention.

### DESCRIPTION OF PREFERRED EMBODIMENTS

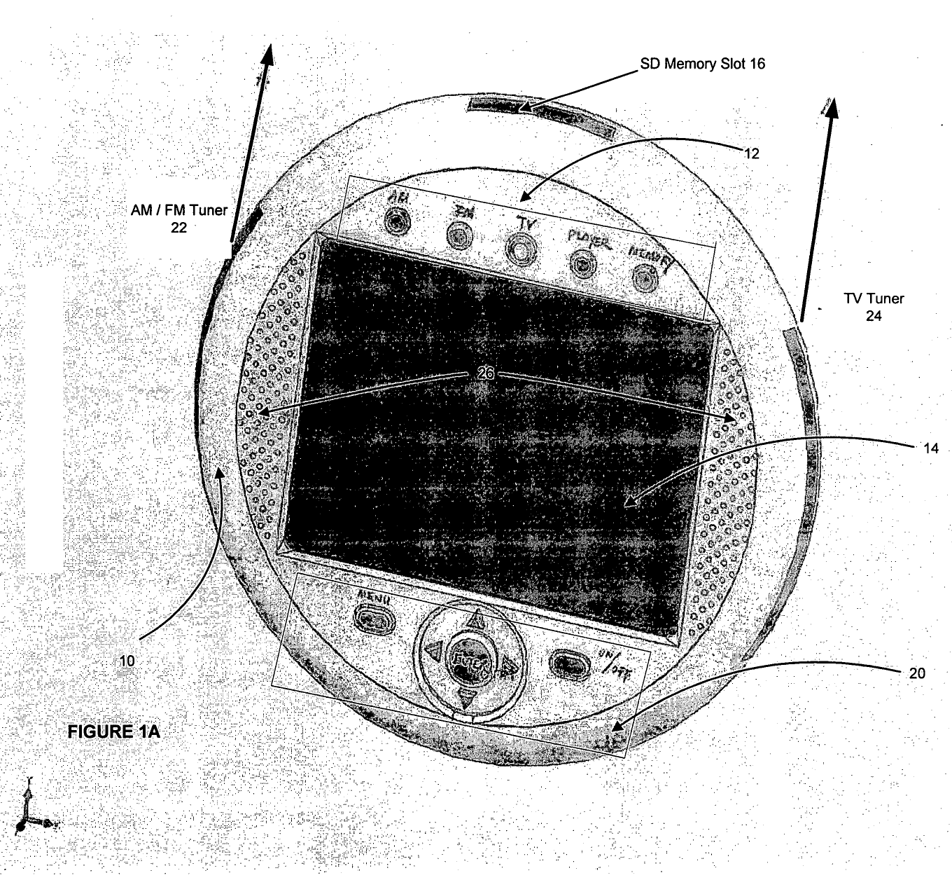

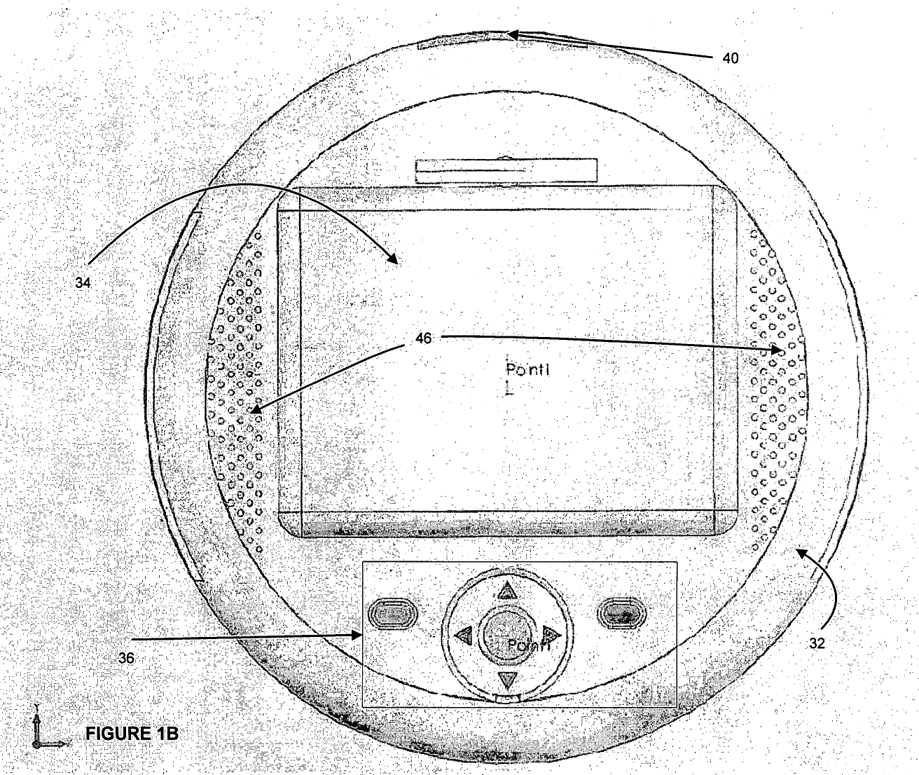

Referring to FIGS. 1A to 6, several preferred embodiments of the present invention will be described. The present invention is directed to a portable, compact media player capable of (1) providing media playback for a variety of multimedia data formats, (2) receiving and playing back television and radio broadcast signals, (3) performing computation functions, and (4) recording multimedia data onto a SD (Secure Digital) memory card or to an optical disc in formats including but not limited to CD-R, CD-RW, DVD-R, DVD+R, DVD-RW, and DVD+RW.

Referring to FIG. 1A, a first preferred embodiment of the present invention is shown, including a display screen 14 in the center of media player 10. In one embodiment, the display screen is a 3.5 inch TFT (Thin Film Transistor) display. The display may be a full color display or a single color display. Though a 3.5 inch TFT is shown in this embodiment, displays using other technologies and/or sizes can be used in the present invention. In one embodiment, when the player is in PDA mode, the display also serves as a touch-screen input for the selection of menu items with a stylus pen. Along with display screen 14, a pair of stereo speakers 26 is also provided. Preferably, by default and upon power up, the player displays a menu on display 14 and launches applications embedded in the operating system of the player in response to a user selection. In the preferred embodiment, control panel 20 or touch-screen interface 14 is provided for the selection of an application.

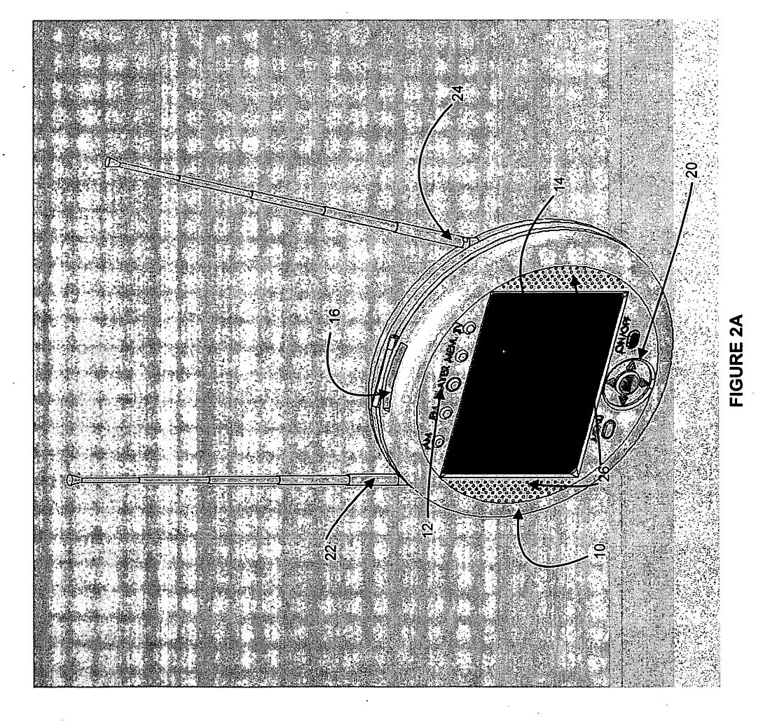

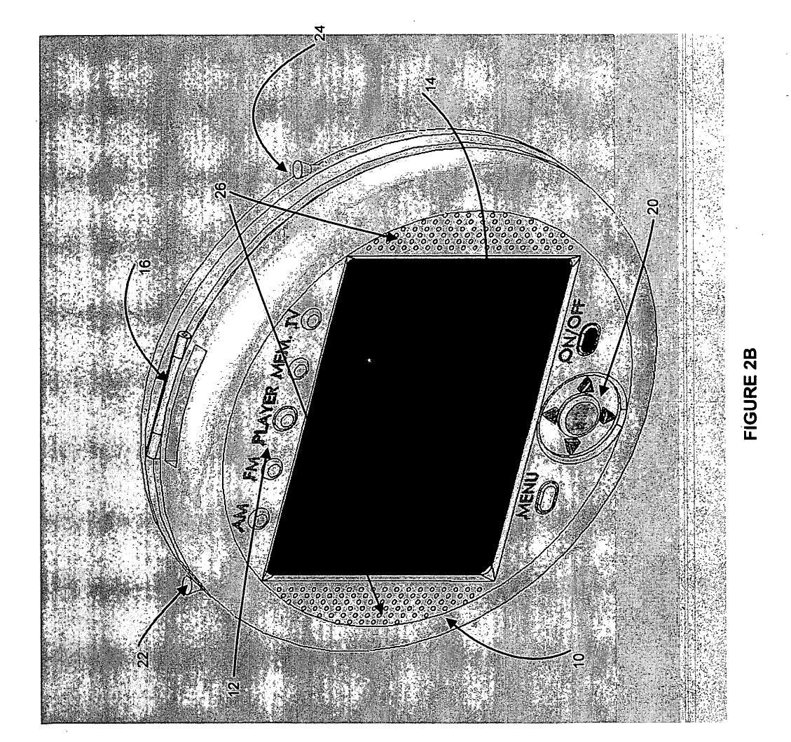

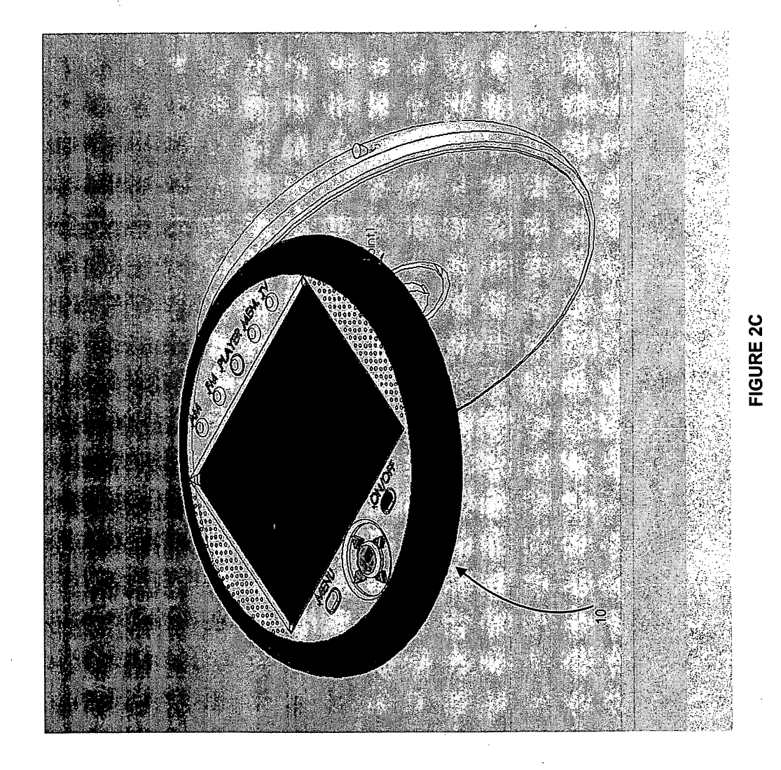

Media source selection buttons 12, or source selectors, are provided for the selection of media play-back functions of the player. As indicated in the figure, the source of the display can be from the media player (the “player” button), broadcast television (the “TV” button), AM radio (the “AM” button), or FM radio (the “FM” button). Other radio such as XM radio signals are also within the scope of the present invention. The media player is capable of playing a wide variety of optical disc media types such as CD, CD-R, CD-RW, VCD, DVD, DVD-R, DVD-RW, DVD+R, DVD+RW, etc. FIG. 2C shows media player 10's capability to open like a clam-shell and to receive an optical disc within the shell of the player. Using conventional techniques the player detects the type of disc inserted and plays back data on the disc accordingly. For example, when an audio disc such as a CD is inserted, the player plays back the audio recorded on the disc. When a CD with MP3 media files is inserted, the player decodes the MP3 files on the disc and plays back the MP3 media. When a video disc such as a VCD or DVD is inserted, the player plays the video recorded on the disc. The player is also adapted to receive a blank disc and record multimedia signals such as video and audio onto the disc. In the preferred embodiment, the player is capable of recording in formats including, but not limited to, CD-R, CD-RW, DVD-R, DVD+R, DVD-RW, and DVD+RW formats. The player can record an external video or audio source through the external A/V connection on the player or record directly the received broadcast TV or radio signals. As shown in FIG. 2A antenna 22 is provided to receive AM/FM/XM signals while antenna 24 is provided to receive TV broadcast signals.

One source button is a “memory” button that provides access to the memory card media playback functionality. As shown in FIG. 1A, memory card slot 16 is provided to receive a SD (secure digital) memory card. In one embodiment, the compact media player displays the media content (e.g. video, digital still images) stored on the memory card. In another embodiment, the compact media player records multi-media content onto the memory card.

FIG. 1A shows an example combination of media buttons and their associated functionalities. It can be appreciated by those skilled in the art that other combinations, sub-combinations and configurations are possible. Also, in other embodiments, media source selection can be provided by interfacing with touch-screen 14.

Control panel 20 controls the operation of compact media player 10 in the FIG. 1 embodiment. Control panel 20 provides an on/off button for turning on or off the compact media player and a plurality of other buttons for accessing the menu displayed on display 14. The arrow-shaped buttons can also be used to forward, backward, or otherwise locate tracks on an audio or video optical disc during playback. The control panel also provides an interface to the device's operating system. In one embodiment, the compact media player runs a Linux operating system on an Intel XScale processor, a commercially available microprocessor, and a conventional DVD chip controller. Other operating systems and microprocessors can be used as well.

FIGS. 2A to 2C show the various perspective views of the embodiment shown in FIG. 1A. FIG. 2A shows media player 10 from FIG. 1A, with antennas 22 and 24 fully extended. Antennas 22 and 24 are retractable and can be retracted into player 10 when not it use. FIG. 2B shows the antennas retracted. FIG. 2C shows compact media player 10 in an “opened” position, whereby an optical disc with media data can be inserted into the player.

With reference to FIG. 1B, a second preferred embodiment of the invention is shown. In this embodiment, fold-down screen 34 covers a portion of the front face of compact media player 32. Source buttons are concealed by fold-down screen 34. Control panel 36 is still accessible. Player 32, as with the first embodiment, also includes speakers 46.

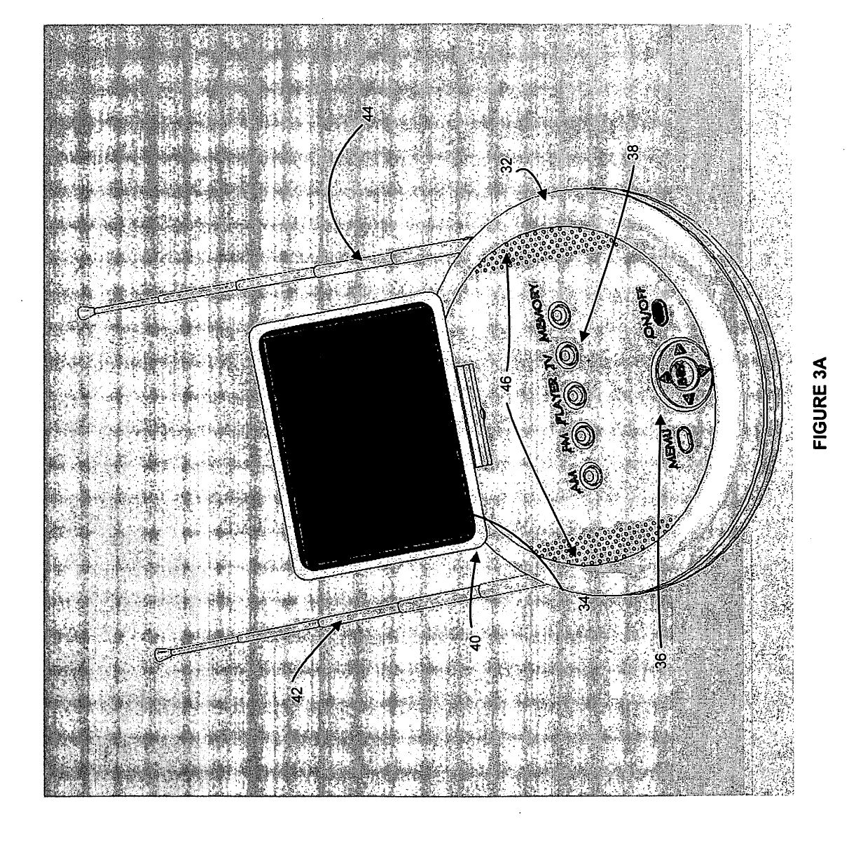

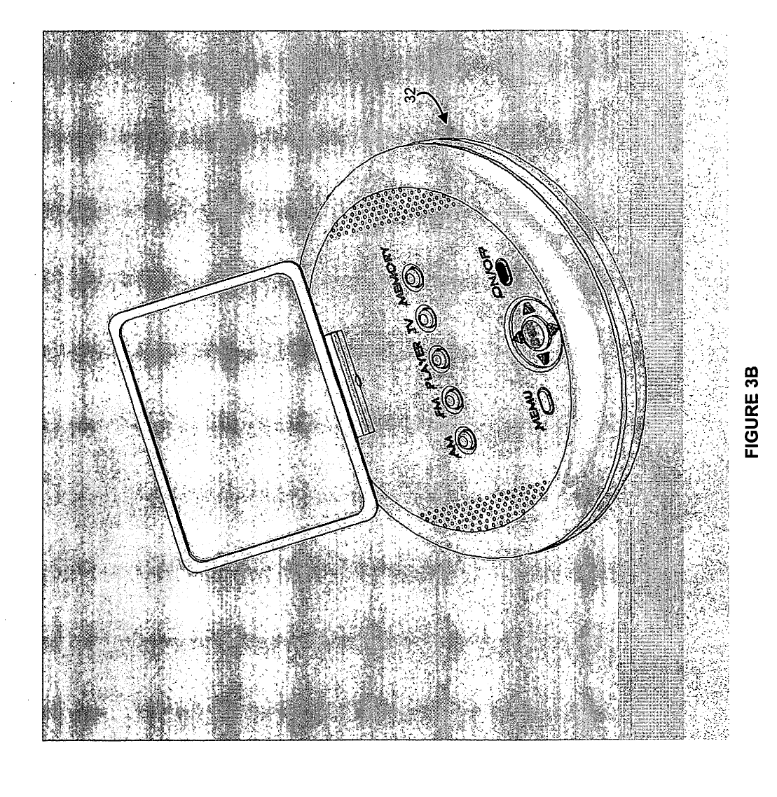

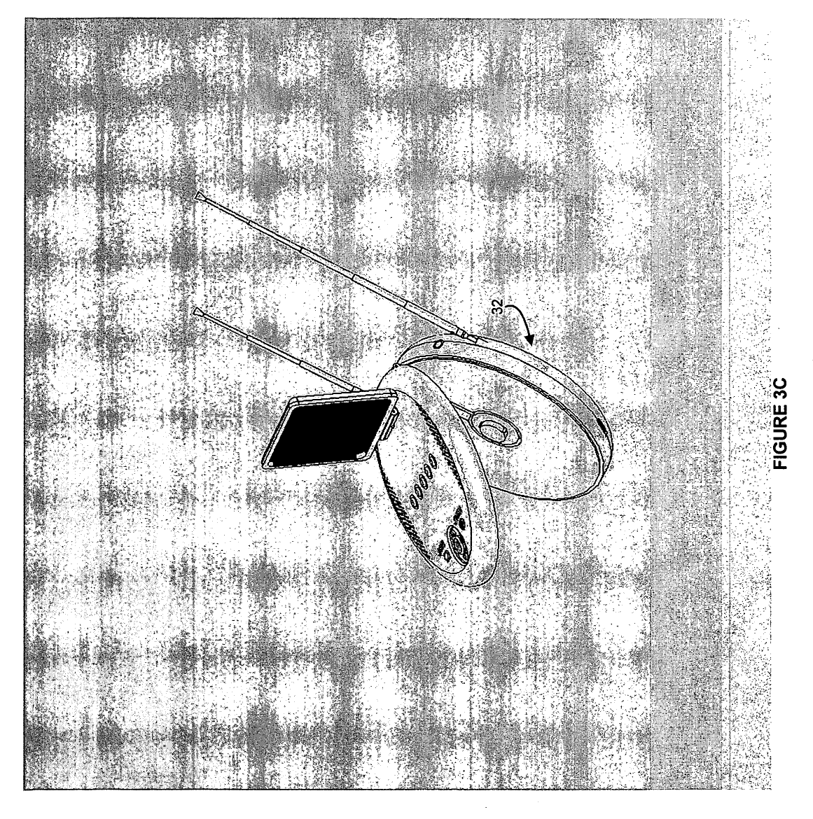

FIGS. 3A to 3C show the various perspective views of the embodiment shown in FIG. 1B. FIG. 3A shows the fold-down screen 34 in the “open” position. Display screen 34 is folded up and its angle can be adjusted for optimal viewing. In one embodiment, the display screen is a 3.5 inch TFT display. The display may be a full color display or a single color display. Although a 3.5 inch TFT is shown in this embodiment, displays using other technologies and/or sizes can be used. In one embodiment, when the player is in PDA mode, the display also serves as a touch-screen input for the selection of menu items with a stylus pen. In this embodiment various regions on the touch screen are provided with appropriate, preferably descriptive graphics and these regions then function as the source selectors.

Preferably, by default, upon power up, the player displays a menu on interface 34 and launches applications embedded in the operating system of the player in response to a user selection. In the preferred embodiment, control panel 36 or touch-screen interface 34 is provided for the selection of an application.

As with the first preferred embodiment, this embodiment includes media source buttons 38. As indicated in the figure, the source of the display can be from the media player (the “player” button), broadcast television (the “TV” button), AM radio (the “AM” button), and FM radio (the “FM” button). The media player is capable of playing a wide variety of optical disc media types such as CD, CD-R, CD-RW, VCD, DVD, DVD-R, DVD-RW, DVD+R, DVD+RW, etc. FIG. 3C shows that media player 32 can be opened like a clam-shell and is adapted to receive an optical disc into the player. Using conventional techniques, the player detects the type of disc inserted and plays back media on the disc accordingly. For example, when an audio disc such as a CD is inserted, the player plays back the audio recorded on the disc. When a CD with MP3 media files is inserted, the player decodes the MP3 files on the disc and plays back the media. When a video disc such as a VCD or DVD is inserted, the player plays the video recorded on the disc. The player is also adapted to receive a blank disc and record multimedia signals such as video and audio onto the disc. In the preferred embodiment, the player is capable of recording in formats including, but not limited to, CD-R, CD-RW, DVD-R, DVD+R, DVD-RW, and DVD+RW formats. The player can record an external video or audio source through the external A/V connection on the player or record directly the received broadcast TV or radio signals.

Referring to FIG. 3A, antenna 42 is provided to receive AM/FM signals while antenna 44 is provided to receive TV broadcast signals. Memory card slot 40, which is behind screen 34, is provided for receiving a SD memory card into player 32. In one embodiment, the compact media player displays the media content (e.g. video, digital still images) stored on the memory card. In another embodiment, the compact media player records multi-media content onto the memory card. Antennas 42 and 44 are retractable and can be retracted into player 32 when not it use. FIG. 3B shows the antennas retracted. FIG. 3C shows compact media player 32 in an “opened” position, whereby an optical disc with media data can be inserted into the player.

FIG. 1B shows an example combination of media buttons and their associated functionalities. It can be appreciated by those skilled in the art that any other combination, sub-combination and configuration are possible. Also, in other embodiments, media source selection can be provided by interfacing with touch-screen 34.

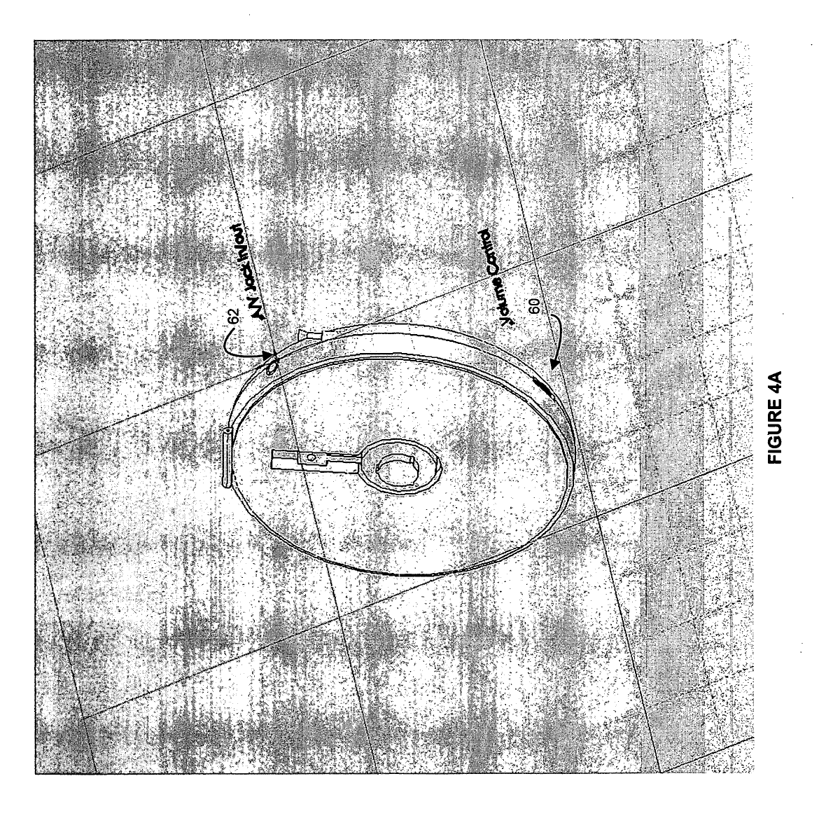

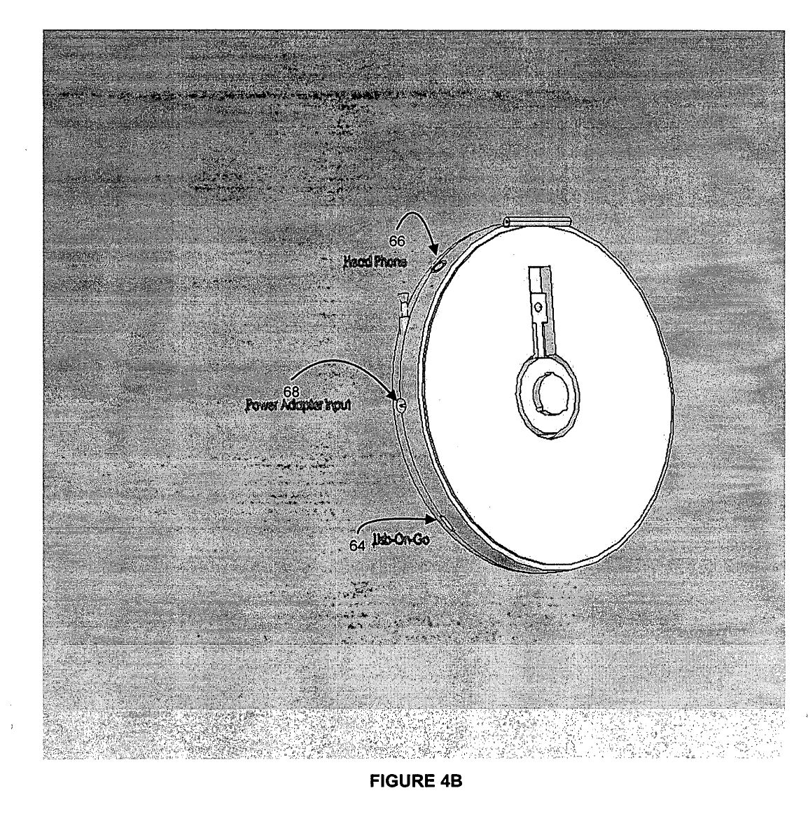

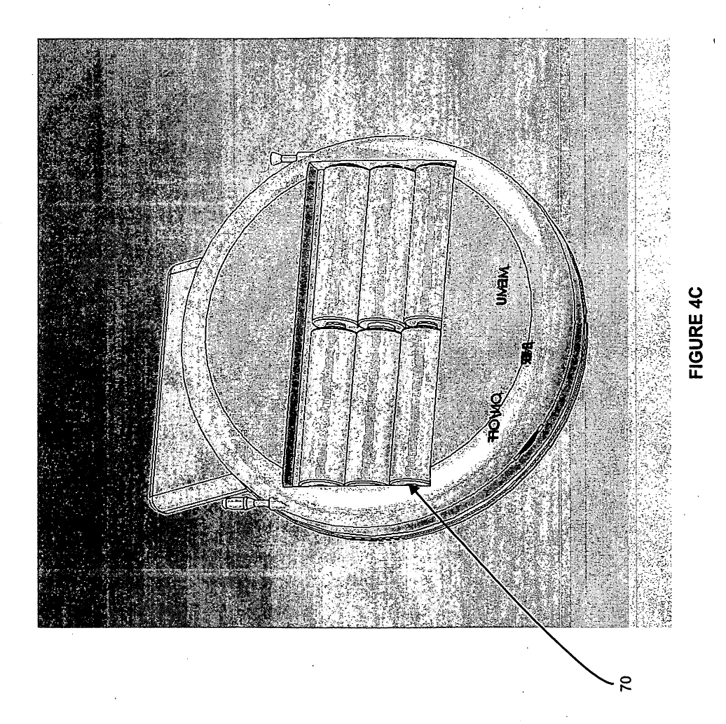

Both preferred embodiments provide a plurality of input and output interfaces for media data input and output. FIGS. 4A-4B show cut-away views of the compact media player with these connections. FIG. 4A shows A/V jack 62 provided for outputting video signals to TVs and digital projectors. Volume control 60 is provided for controlling the volume of media playback. FIG. 4B shows that stereo phone jack 66 is provided for connecting a headphone to the player. Power adapter input 68 is provided for connecting a power adapter. In the preferred embodiment, the media player can also be powered by batteries, such as 6 AA batteries. For example, FIG. 4C shows that battery compartment 70 is provided for 6 AA batteries. Shown in FIG. 4B is a USB-On-The-Go interface 64 for data transfer and interfacing with any USB compliant device such as a PC or a mobile phone. Alternatively, a wireless interface may also be included in the player of the present invention.

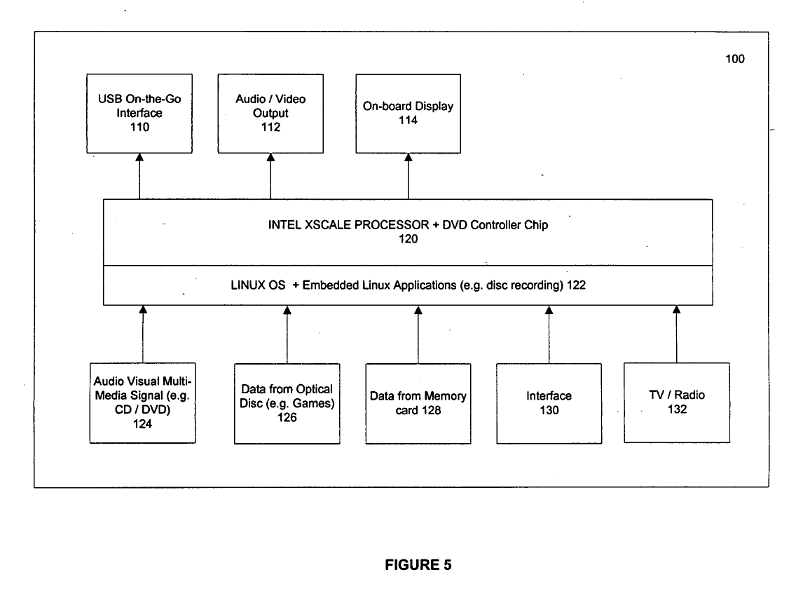

FIG. 5 is a schematic diagram of internal components 100 of an embodiment of the media player of the present invention. Intel XScale processor and DVD controller chip 120 are used to process various multi-media signals as well as perform computational tasks associated with Linux operating system 122. Along with the Linux operating system is a plurality of Linux-based applications for controlling the functionalities of the player (e.g. disc recording software). It can be appreciated that other operating systems such as Windows CE or Palm OS can be used. The Intel XScale processor is readily available on the market and is optimized for low power consumption and high power processing. Hence, the processor is suited for portable computing applications. Also, the XScale processor has built-in TFT output functions and other embedded functions to handle multi-media decoding tasks such as DVD and MP3 playback. Though the XScale processor is used, it is understood that other comparable processors can be used as well.

Interface 130 provides an interface to Linux operating system 122. The interface includes a control panel and/or touch screen display for controlling the operating system. In one embodiment, an on-screen keyboard in provided for input of data. In another embodiment, the display serves as a touch-screen input for the selection of menu items. Multi-media signals 124 from the optical disc player are processed also by processor 120. The result is output to display 114, A/V output 112, or USB on-the-go interface 110. The term USB on-the-go interface is used as it is generally understood in the field. In general, USB on-the-go interfaces are made for interfacing among portable devices without a PC host. As such, components for USB on-the-go are known in the art and can be readily incorporated into the present invention to provide USB interface capability for the exchange of media data. Also, the present invention preferably uses a 3.5 inch TFT display for TFT display. Such displays are common in camcorders, mobile phones, and PDAs and are manufactured by a number of semiconductor manufacturers such as Samsung Semiconductors.

The same output options (110, 112, and 114) are also available for broadcast TV/radio signals 132, data from memory card 128, and data from optical disc (e.g. games) 126. As such, the media player of the present invention can also function as a video game player, wherein a Linux-based game on the optical disc can be launched on embedded Linux operating system 122. The control panel as shown in FIGS. 1A and 1B can be used as a joystick-like control for the playing video games. It will be understood that certain features, alternative combinations and sub-combinations are of utility and may be employed without reference to other features and subcombinations as they are outlined in FIG. 5.

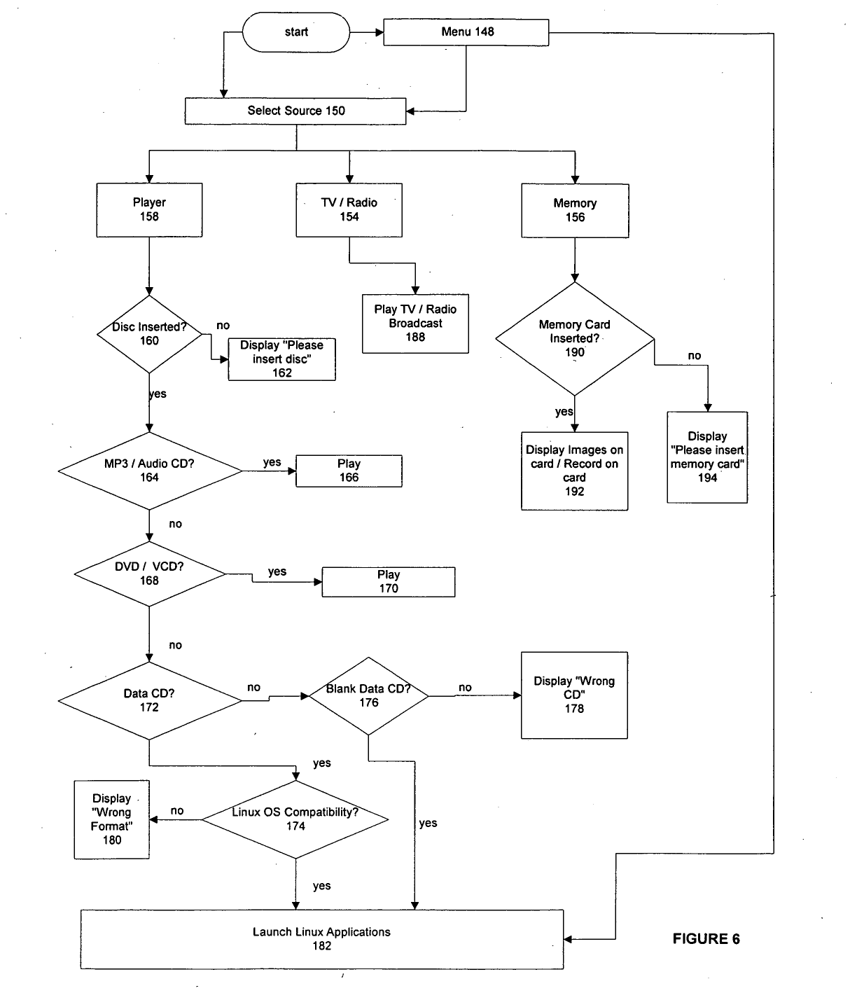

FIG. 6 is a flowchart that shows the software operation of the media player according to an embodiment of the present invention. Upon power up, the compact media player preferably displays the menu interface in step 148. The control panel or the touch-screen is provided for the selection of an application. In one embodiment, the player includes PDA functionalities and an application is launched in step 182 upon a selection. Alternatively, one of the source buttons is selected in step 150. If the “player” button is selected in step 158, then in step 160 a query is made as to whether a disc has been inserted. If not, a prompt “please insert disc” will be displayed in step 162. Otherwise, the player will see if it is an audio CD in step 164. If so, the CD will play in step 166. If not, the player will see if it is a VCD or DVD in step 168. If so, the VCD or DVD will play in step 170. If not, the player will see if it is a data CD in step 172. If so, the player will check whether it is Linux compatible in step 174. If not, a “wrong format” message will be displayed in step 180. Otherwise the Linux applications on the disc will be launched in step 182. If the disc is not a data CD, a check will be performed in step 176 to see if it is a blank disc. If so, a Linux disc recording application will be launched to write data to the blank disc (step 182). If not, a “wrong CD” error message will be displayed to the user in step 178.

If a TV or Radio button is selected (i.e., “TV” or “AM” or “FM”) in step 154, the appropriate broadcast signal will be played back by the player in step 188. If the “memory” button is selected in step 156, the player will check whether a memory card has been inserted in step 190. If so, the images on the memory card will be displayed in step 192 or media content will be recorded onto the card. If not, a message “please insert memory card” will be displayed in step 194.

It will be understood that certain features and subcombinations are of utility and may be employed without reference to other features and subcombinations as they are outlined within the description above and within the claims appended thereto. While the preferred embodiments and application of the invention have been described, it is apparent to those skilled in the art that the objects and features of the present invention are only limited set forth in the claims appended hereto.

1. A media player comprising:
a component adapted to play back audio data stored in an optical disc format;
a component adapted to play back video data stored in an optical disc format;
a component adapted to record media data to an optical disc format;
a component adapted to perform computing functions;
a component adapted to receive TV broadcast signals and to display corresponding images on a display screen;
a component adapter to receive and play radio broadcast signals;
a component adapted to interface with a media device; and
a component adapted to record incoming media data from said other media device.

2. The media player of claim 1 having a top view that is circular in shape.

3. The media player of claim 1 further comprising a top section and a bottom section attached to said top section by a hinge.

4. The media player of claim 1 wherein said optical disc format is any one of CD, CD-R, CD-RW, VCD, DVD, DVD-R, DVD+R, DVD-RW, or DVD+RW.

5. The media player of claim 3 further comprising:
a display screen positioned in said top section;
a pair of speakers positioned in said top section;
a first tuner positioned in said bottom section;
a second tuner positioned in said bottom section; and
a plurality of media source selectors positioned on said top section.

6. The media player of claim 1 wherein said display screen is a touch-screen.

7. The media player of claim 6 wherein regions on said display screen are adapted to function as the plurality of media source selectors.

8. The media player of claim 3 further comprising: a fold-down display screen positioned in the top section.
